(19) United States
(12) Patent Application Publication
(10) Pub. No.: US 2006/0160054 A1
(43) Pub. Date: Jul. 20, 2006

(54) Automatic grading apparatus, method and storage medium of automatic grading

(75) Inventors: Ayumi Onishi, Ebina-shi (JP); Nobuo Inoue, Ebina-shi (JP); Minoru Sodeura, Ebina-shi (JP); Masataka Kamiya, Ebina-shi (JP); Junji Kannari, Ebina-shi (JP); Sadao Furuoya, Ebina-shi (JP); Norio Hasegawa, Saitama-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/298,849

(22) Filed: Dec. 12, 2005

(30) Foreign Application Priority Data
Jan. 19, 2005 (JP) 2005-011542

(51) Int. Cl. G09B 3/00

(52) U.S. Cl. 434/322; 434/362

(57) ABSTRACT

An automatic grading method has processes of reading, identifying and calculating. A process of reading a document is performed and the document has one or more answers. A process of identifying the answers from the document is also performed. A process of calculating a score of the document based on a score of each answer is performed.

### BACKGROUND

1. Technical Field

The present invention relates to an automatic grading apparatus that automatically grades a document such as an answer sheet by reading the answer sheet with an image reading apparatus such as a scanner, and which creates a database of the grading result or prints/outputs the grading result on the answer sheet as needed.

2. Related Art

Conventionally, answer sheets have been graded by automatic grading using a mark sheet or, as disclosed in JP-A-7-199794, by an image processor configured to grade answer sheets by recognizing symbols and marks with digital image processing and comparing these to correct answers. As disclosed in JP-A-11-224245, a grading system has also been proposed which is configured to automatically grade answer sheets by using a dedicated pad and pen and detecting the state of the pen.

However, the above-described related art has the following drawbacks. That is, in the cases of automatic grading with a mark sheet and the image processor disclosed in JP-A-7-199794, if the answers are other than symbols, characters, or marks, as in problems that are answered by text and figures, the answers cannot be recognized by the answer recognizing unit, and the answers cannot be graded.

Also, because the grading system disclosed in JP-A-11-224245 is configured to automatically grade answer sheets by using a dedicated pad and pen and detecting the state of the pen, dedicated hardware such as the dedicated pad and pen are required, and the configuration becomes complicated and expensive.

### SUMMARY

According to an aspect of the present invention, an automatic grading method is provided. The method has processes of reading, identifying and calculating. A process of reading a document is performed and the document has one or more answers. A process of identifying the answers from the document is also performed. A process of calculating a score of the document based on a score of each answer is performed.

### BRIEF DESCRIPTION OF THE DRAWINGS

An embodiment of the invention will be described in detail based on the following figures, wherein:

FIG. 1 is a block diagram showing an automatic grading apparatus according to an embodiment of the invention;

FIG. 2 is a configural diagram showing an image processing system to which is applied the automatic grading apparatus according to the embodiment of the invention;

FIG. 3 is a configural diagram showing a color complex machine serving as an image output apparatus to which is applied the automatic grading apparatus according to the embodiment of the invention;

FIG. 4 is a configural diagram showing image forming units in the color complex machine serving as the image output apparatus to which is applied the automatic grading apparatus according to the embodiment of the invention;

FIG. 5 is a configural diagram showing an image reading apparatus to which can be applied the automatic grading apparatus according to the embodiment of the invention;

FIGS. 6A and 6B are explanatory diagrams showing an answer sheet graded by the automatic grading apparatus according to the embodiment of the invention;

FIG. 7 is an explanatory diagram showing identification information identified by the automatic grading apparatus according to the embodiment of the invention;

FIGS. 8A and 8B are explanatory diagrams showing identification information identified by the automatic grading apparatus according to the embodiment of the invention;

FIG. 9 is an explanatory diagram showing identification information identified by the automatic grading apparatus according to the embodiment of the invention;

FIG. 10 is a chart showing correct answer information;

FIG. 11 is an explanatory diagram showing an automatic grading result of an answer sheet; and

FIG. 12 is a chart showing a database created on the basis of the automatic grading result of the answer sheet.

### DETAILED DESCRIPTION

An embodiment of the present invention will be described below on the basis of the drawings.

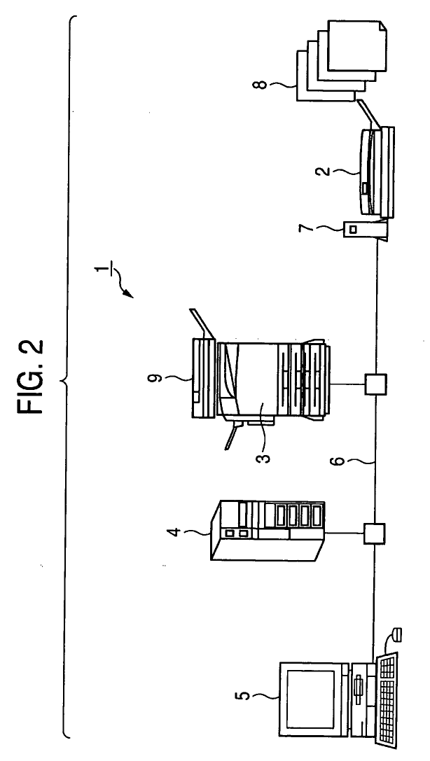

FIG. 2 shows an image processing system 1 to which is applied an automatic grading apparatus according to the embodiment of the invention.

As shown in FIG. 2, the image processing system 1 is configured to include a scanner 2 serving as an independently disposed image reading apparatus; a color multifunctional machine 3 serving as an image output apparatus; a server 4 serving as a database; a personal computer 5 serving as an image creating apparatus that creates a document such as an answer sheet; and a network 6 having a LAN or telephone line that communicably interconnects the scanner 2, the color multifunctional machine 3, the server 4, and the personal computer 5. In FIG. 2, reference numeral 7 represents a modem that communicably connects the scanner 2 to the network 6.

The scanner 2 is an apparatus which, when images of answer sheets 8 are to be read to automatically grade the answer sheets 8 or create a database, reads the images of the answer sheets 8 and outputs image data of the answer sheets 8. The image data of the answer sheets 8 read by the scanner 2 are sent via the network 6 to the color multifunctional machine 3, where predetermined image processing is administered to the image data by an image processing apparatus disposed in the color multifunctional machine 3. Thereafter, the image data are automatically graded by the automatic grading apparatus disposed in the image processing apparatus. Rather than being disposed inside the color multifunctional machine 3, the automatic grading apparatus may also be configured such that it is installed as automatic grading software in the personal computer 5, whereby the personal computer 5 itself may function as the automatic grading apparatus.

The color multifunctional machine 3 includes a scanner 9 serving as an image reading apparatus by itself. The color multifunctional machine 3 copies images of documents read by the scanner 9, prints grading results on the answer sheets 8, prints on the basis of image data sent from the personal computer 5 and read from the server 4, and functions as a fax that sends and receives image data via a telephone line.

The server 4 is an apparatus that stores the image data of the answer sheets 8 as is, or stores and retains data that have been read by the scanners 2 and 9, graded by the automatic grading apparatus, and put into a database.

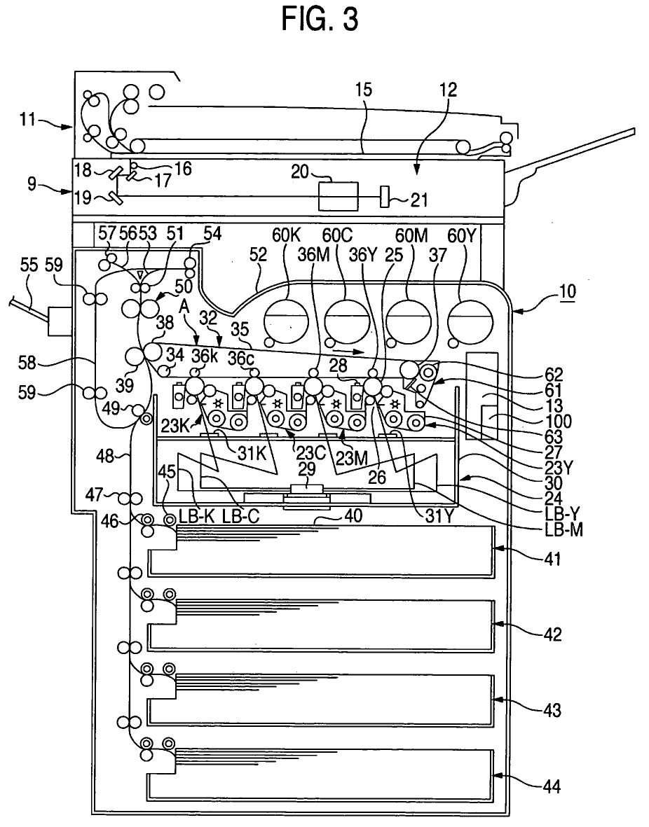

FIG. 3 shows the color multifunctional machine 3 serving as an image output apparatus to which is applied the automatic grading apparatus according to the embodiment of the invention.

In FIG. 3, reference numeral 10 represents the body of the color multifunctional machine 3. The scanner 9 is disposed in the upper portion of the color multifunctional machine 3, and serves as an image reading apparatus including an automatic document feeder (ADF) 11, which automatically feeds documents 8 such as the answer sheets one sheet at a time, and an image input terminal (IIT) 12, which reads images of the documents 8 fed by the automatic document feeder 11. It will be noted that the scanner 2 is configured in the same manner as the scanner 9. The image input terminal 12 is configured to illuminate, with a light source 16, the document 8 placed on a platen glass 15, scan/expose the reflection light image from the document 8 onto an image reading element 21 having a CCD or the like via a reduction optical system having a full-rate mirror 17, half-rate mirrors 18 and 19, and an imaging lens 20, and read, at a predetermined dot density (e.g., 16 dots/mm), the color material reflection light image of the document 8 with the image reading element 21.

The reflection light image of the document 8 read by the image input terminal 12 is sent as reflection ratio data of the three colors of red (R), green (G) and blue (B) (each 8 bit) to an image processing system (IPS) 13 disposed inside the color complex machine body 10. In the image processing system 13, predetermined image processing, including processing such as shading correction, positional displacement correction, brightness/color space conversion, gamma conversion, frame elimination, and color/movement editing, is administered as needed to the image data of the document 8 as described later. The image processing system 13 is also configured to conduct predetermined image processing as needed also with respect to image data sent from the personal computer 5 or the like. An automatic grading apparatus 100 according to the present embodiment is incorporated in the image processing system 13.

The image data to which predetermined image processing has been administered in the image processing system 13 are similarly converted to gradation data of the four colors of yellow (Y), magenta (M), cyan (C) and black (K) (each 8 bit) by the image processing system 13, and as will be described next, are sent to a raser output scanner (ROS) 24 shared by image forming units 23Y, 23M, 23C and 23K of the respective colors of yellow (Y), magenta (M), cyan (C) and black (K). In the ROS 24 serving as an image exposure apparatus, image exposure resulting from laser beams LB is conducted in accordance with the gradation data of the predetermined colors. The image is not limited to a color image; just a black-and-white image may also be formed.

Incidentally, as shown in FIG. 3, image forming unit A are disposed inside the color multifunctional machine 3. The four image forming units 23Y, 23M, 23C and 23K of yellow (Y), magenta (M), cyan (C) and black (K) are disposed in the image forming unit A in parallel at predetermined intervals in the horizontal direction.

The four image forming units 23Y, 23M, 23C and 23K are all configured in the same manner. That is, each of the image forming units 23 generally includes a photoconductor drum 25 serving as an image carrier that is rotated/driven at a predetermined speed; a primary charge-use charge roll 26 that uniformly charges the surface of the photoconductor drum 25; the ROS 24 serving as an image exposure apparatus that forms an electrostatic latent image on the surface of the photoconductor drum 25 by exposing an image corresponding to a predetermined color; a developer 27 that develops, with toner of a predetermined color, the electrostatic latent image formed on the photoconductor drum 25; and a cleaning device 28 that cleans the surface of the photoconductor drum 25. The photoconductor drums 25 and the image forming members disposed in their vicinity are integrally unitized and configured to be individually replaceable with respect to the color complex machine body 10.

As shown in FIG. 3, the ROS 24 is configured to be shared by the four image forming units 23Y, 23M, 23C and 23K. The ROS 24 is also configured to modulate four unillustrated semiconductor lasers in accordance with the gradation data of the respective colors and to emit, in accordance with the gradation data, laser beams LB-Y, LB-M, LB-C and LB-K from the semiconductor lasers. The ROS 24 may also be configured such that one ROS is individually disposed for each of the plural image forming units. The laser beams LB-Y, LB-M, LB-C and LB-K emitted from the semiconductor lasers are emitted onto a polygon mirror 29 via an unillustrated f- [symbol] lens and deflected/scanned by the polygon mirror 29. The laser beams LB-Y, LB-M, LB-C and LB-K deflected/scanned by the polygon mirror 29 are scanned/exposed from diagonally below to exposure points on the photoconductor drums 25 via an unillustrated imaging lens and plural mirrors.

Because the ROS 24 scans/exposes an image onto the photoconductor drums 25 from below as shown in FIG. 3, there is the potential for the ROS 24 to become tainted as a result of toner or the like falling onto the ROS 24 from the developers 27 of the four image forming units 23Y, 23M, 23C and 23K positioned above the ROS 24. For this reason, the periphery of the ROS 24 is sealed by a rectangular parallelepiped frame 30, and windows 31Y, 31M, 31C and 31K made of transparent glass serving as shield members are disposed in the upper portion of the frame 30 in order to expose the four laser beams LB-Y, LB-M, LB-C and LB-K onto the photoconductor drums 25 of the image forming units 23Y, 23M, 23C and 23K.

Image data of the respective colors are sequentially outputted from the image processing system 13 to the ROS 24 shared by the image forming units 23Y, 23M, 23C and 23K of the respective colors of yellow (Y), magenta (M), cyan (C) and black (K). The laser beams LB-Y, LB-M, LB-C and LB-K emitted from the ROS 24 in accordance with the image data are scanned/exposed on the surfaces of the corresponding photoconductor drums 25, whereby electrostatic latent images are formed on the surfaces of the photoconductor drums 25. The electrostatic latent images formed on the photoconductor drums 25 are developed as toner images of the respective colors of yellow (Y), magenta (M), cyan (C) and black (K) by the developers 27Y, 27M, 27C and 27K of the respective colors of yellow (Y), magenta (M), cyan (C) and black (K).

The toner images of the respective colors of yellow (Y) magenta (M), cyan (C) and black (K) sequentially formed on the photoconductor drums 25 of the image forming units 23Y, 23M, 23C and 23K are multiply transferred by four primary transfer rolls 36Y, 36M, 36C and 36K onto an intermediate transfer belt 35 of a transfer unit 32 disposed across and above the image forming units 23Y, 23M, 23C and 23K. The primary transfer rolls 36Y, 36M, 36C and 36K are disposed at the undersurface side of the intermediate transfer belt 35 corresponding to the photoconductor drums 25 of the image forming units 23Y, 23M, 23C and 23K. The volume resistance values of the primary transfer rolls 36Y, 36M, 36C and 36K in the present embodiment are adjusted to 105 to 108 Ωcm. Transfer bias power supplies (not shown) are connected to the primary transfer rolls 36Y, 36M, 36C and 36K such that transfer biases of the opposite polarity (in the present embodiment, positive polarity) to predetermined toner polarities are applied at a predetermined timing.

As shown in FIG. 3, the intermediate transfer belt 35 is wound at a constant tension around a drive roll 37, a tension roll 34, and a backup roll 38. The intermediate transfer belt 35 is circulated/driven at a predetermined speed in the direction of the arrow by the drive roll 37, which is rotated/driven by an unillustrated dedicated drive motor having excellent constant speed characteristics. The intermediate transfer belt 35 is configured by a non-conductive belt material (rubber or resin).

As shown in FIG. 3, the toner images of the respective colors of yellow (Y), magenta (M), cyan (C) and black (K) multiply transferred onto the intermediate transfer belt 35 are secondarily transferred onto paper 40 serving as a sheet material by a secondary transfer roll 39 that pressingly contacts the backup roll 38. The paper 40 to which the toner images of the respective colors have been transferred is conveyed to a fixer 50 disposed above the secondary transfer roll 39. The secondary transfer roll 39 is configured to pressingly contact the side of the backup roll 38 and secondarily transfer the toner images of the respective colors onto the paper 40 conveyed upward from below.

Sheets of a predetermined size of the paper 40 are supplied one sheet at a time by a feed roll 45 and a retard roll 46 via a paper conveyance path 48 disposed with conveyance rolls 47 from any of paper supply trays 41, 42, 43 and 44 plurally disposed in the lower portion of the color complex machine body 10. The paper 40 supplied from any of the paper supply trays 41, 42, 43 and 44 is temporarily stopped by a registration roll 49 and again supplied to a secondary transfer position of the intermediate transfer belt 35 by the registration roll 49 in synchronization with the images on the intermediate transfer belt 35.

Then, as shown in FIG. 3, the toner images of the respective colors that have been transferred onto the paper 40 are fixed to the paper 40 with heat and pressure by the fixer 50. Thereafter, the surface of the paper 40 on which the image has been formed is turned face down by conveyance rolls 51, and the paper 40 is discharged, via a first paper conveyance path 53 for discharging the paper 40 into a face-down tray 52 serving as a first discharge tray, into the face-down tray 52 disposed in the upper portion of the color complex machine body 10 by discharge rolls 54 disposed in an outlet of the first paper conveyance path 53.

When the paper 40 on which the image has been formed as described above is to be discharged with the image surface face up, as shown in FIG. 3, the surface of the paper 40 on which the image has been formed is turned face up and the paper 40 is discharged, via a second paper conveyance path 56 for discharging the paper 40 into a face-up tray 55 serving as a second discharge tray, onto the face-up tray 55 disposed at the side portion (the left side in the drawing) of the color complex machine body 10 by discharge rolls 57 disposed in an outlet of the second paper conveyance path 56.

When a two-sided copy such as a full-color copy is to be made in the color multifunctional machine 3, as shown in FIG. 3, the paper 40 to which an image has been fixed to one side is not discharged into the face-down tray 52 by the discharge rolls 54. Rather, the conveyance direction of the paper 40 is switched by an unillustrated switch gate, the discharge rolls 54 are temporarily stopped and then reversely rotated, and the paper 40 is conveyed to a two-sided paper conveyance path 58 by the discharge rolls 54. Then, the paper 40 is again conveyed, by conveyance rolls 59 disposed along the conveyance path 58, to the registration roll 49 in a state where the front and back sides of the paper 40 have been reversed. This time, an image is transferred/fixed to the back side of the paper 40, and the paper 40 is discharged into either the face-down tray 52 or the face-up tray 55 via the first paper conveyance path 53 or the second paper conveyance path 56.

In FIG. 3, reference numerals 60Y, 60M, 60C and 60K respectively represent toner cartridges that supply toners of the predetermined colors to the developers 27Y, 27M, 27C and 27K of the respective colors of yellow (Y), magenta (M), cyan (C) and black (K).

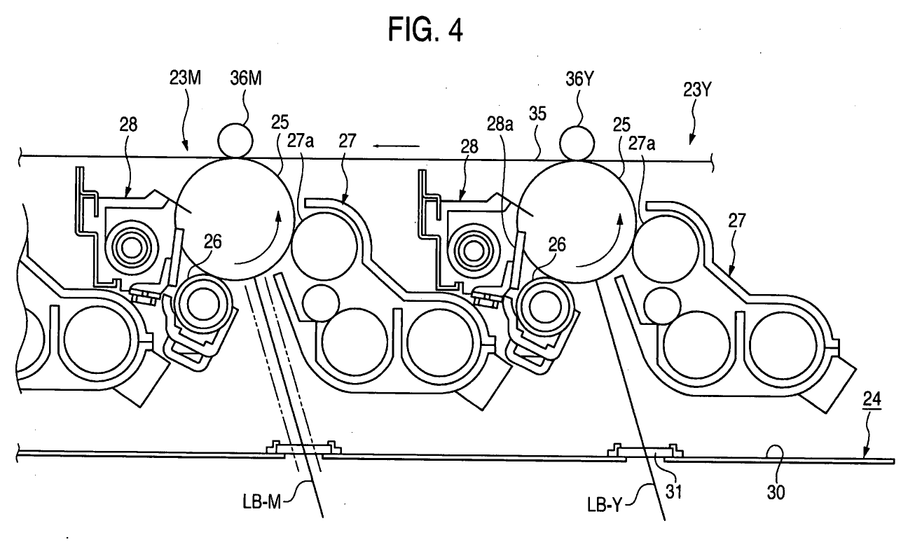

FIG. 4 shows the image forming units 23 in the color multifunctional machine 3.

As shown in FIG. 4, the four image forming units 23Y, 23M, 23C and 23K of the colors of yellow, magenta, cyan and black are all configured in the same manner. As described above, the four image forming units 23Y, 23M, 23C and 23K are configured such that toner images of the colors of yellow, magenta, cyan and black are sequentially formed at a predetermined timing. As described above, each of the image forming units 23Y, 23M, 23C and 23K of the respective colors includes a photoconductor drum 25, and the surfaces of the photoconductor drums 25 are uniformly charged by the primary charge-use charge rolls 26. Thereafter, the image formation-use laser beams LB emitted from the ROS 24 in accordance with image data are scanned/exposed, and electrostatic latent images corresponding to the respective colors are formed, on the surfaces of the photoconductor drums 25. The laser beams LB scanned/exposed onto the photoconductor drums 25 are set such that they are exposed from diagonally downward and slightly to the right from directly underneath the photoconductor drums 25. The electrostatic latent images formed on the photoconductor drums 25 are developed by toners of the corresponding colors of yellow, magenta, cyan and black by developer rolls 27a of the developers 27 in the image forming units 23Y, 23M, 23C and 23K, and become visible toner images. The visible toner images are sequentially multiply transferred onto the intermediate transfer belt 35 by the charge of the primary charge rolls 36.

After the toner images have been transferred, residual toner and paper dust are removed from the surfaces of the photoconductor drums 25 by the cleaning devices 28 such that the photoconductor drums 25 are ready for the next image formation process. Each of the cleaning devices 28 includes a cleaning blade 28a, which removes any residual toner and paper dust from the surfaces of the photoconductor drums 25. Also, after the toner images have been transferred, residual toner and paper dust are removed from the surface of the intermediate transfer belt 35 by a cleaning device 61, as shown in FIG. 3, such that the intermediate transfer belt 35 is ready for the next image formation process. The cleaning device 61 includes a cleaning brush 62 and a cleaning blade 63, which remove any residual toner and paper dust from the surface of the intermediate transfer belt 35.

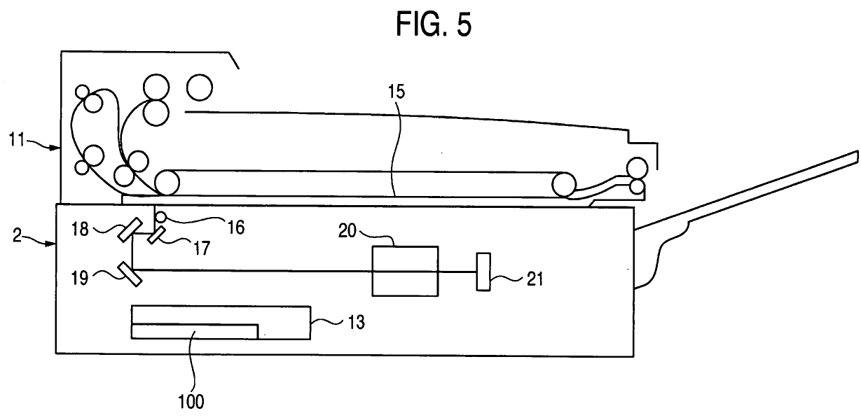

FIG. 5 shows the scanner 2 serving as an independently disposed image reading apparatus.

The scanner 2 is configured in the same manner as the scanner 9 in the color multifunctional machine 3, except that the image processing system 13 is housed in the scanner 2.

According to an aspect of the present invention, an automatic grading apparatus automatically grades a document such as an answer sheet by reading an image of the answer sheet. The answer sheet includes problem, answers answered by text and/or figures and it sometimes includes problems of the answers. The automatic grading apparatus includes an identifying unit. The identifying unit identifies each answer whether the answer is correct or incorrect from the read answer sheet based on correct/incorrect determination information. The correct/incorrect determination information have been determined in advance to be correct or incorrect by a human hand. The automatic grading apparatus also has a score calculating unit that calculates a score from preregistered point allocation information on the basis of the correct/incorrect determination information identified by the identifying unit.

According to an aspect of the present invention, the automatic grading apparatus may include a corresponding unit that which, when the correct/incorrect determination information has been written such that it protrudes from a predetermined frame, discriminates which problem the correct/incorrect determination information corresponds to on the basis of the area ratio of the correct/incorrect determination information written inside the predetermined frame.

According to an aspect of the present invention, automatically gradable answers in the image of the answer sheet may be recognized by a recognizing unit that automatically recognizes automatically gradable answers in the answer sheet, and the automatic grading apparatus may be configured to further include an automatic correct/incorrect determining unit that automatically determines whether the automatically gradable answers are correct or incorrect.

According to an aspect of the present invention, the automatic grading apparatus may be configured to further include an image adding unit that automatically adds, to the answer sheet, an image of the score calculated by the score calculating unit.

According to an aspect of the present invention, the automatic grading apparatus may be configured to further include a database creating unit that creates a database on the basis of the score calculated by the score calculating unit.

According to an aspect of the present invention, the automatic grading apparatus may be configured to further include a warning unit that issues a warning when no correct/incorrect determination information has been written with respect to the problems answered by text and figures.

According to an aspect of the present invention, when no correct/incorrect determination information has been written with respect to the problems answered by text and figures, the automatic grading apparatus may be configured to add the determination result resulting from the automatic correct/incorrect determining unit but does not conduct automatic grading.

In this embodiment, the image adding unit may be configured such that whether or not an image of a correct answer is to be added with respect to an incorrect problem is selectable.

In this embodiment, the image adding unit may be configured to use, as the image of the score to be automatically added to the answer sheet, at least preregistered handwriting font information of a grader.

In this embodiment, the image adding unit may be configured to reduce/enlarge the preregistered handwriting font information to match the sizes of answers and score columns.

That is, as shown in FIG. 3, the automatic grading apparatus 100 is disposed in the color multifunctional machine 3 serving as an image output apparatus in a state where the automatic grading apparatus 100 has been incorporated as part of the image processing system 13. Also, the automatic grading apparatus 100 is configured by installing automatic grading-use software in the personal computer 5 or the like. Moreover, as shown in FIG. 5, the automatic grading apparatus 100 may also be configured such that it is disposed inside the scanner 2 serving as an image reading apparatus in a state where the automatic grading apparatus 100 has been incorporated as part of the image processing system 13.

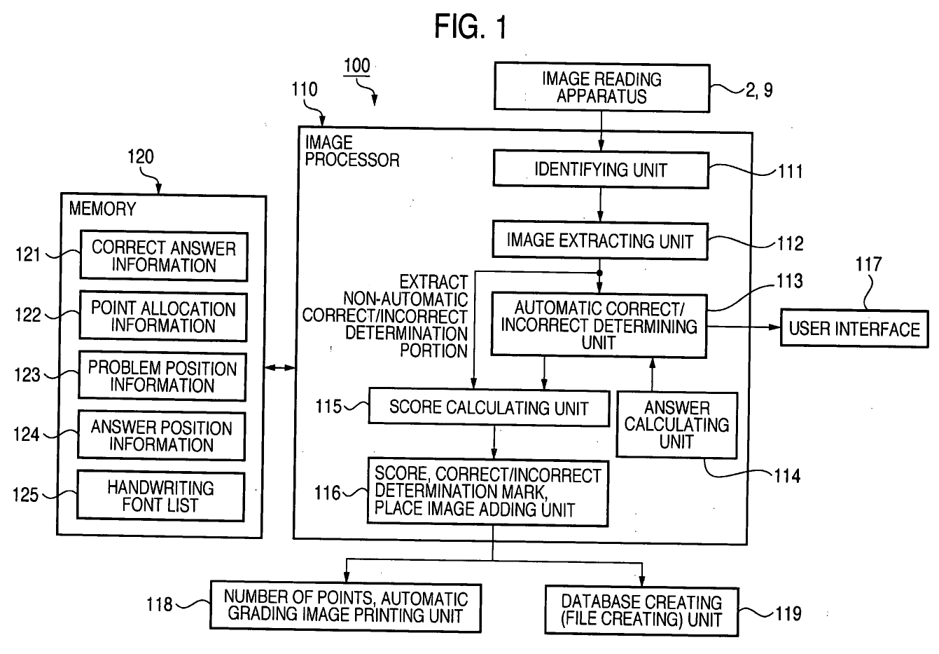

As shown in FIG. 1, the automatic grading apparatus 100 is mainly configured by an image processor 110 and a memory 120. The image processor 110 includes an identifying unit 111 that identifies correct or incorrect of an answer by reading a mark or comment or the like. The image processor 110 also has an image extracting unit 112, an automatic correct/incorrect determining unit 113, an answer calculating unit 114, a score calculating unit 115, and an image adding unit 116. A user interface 117 serving as warning means is connected to the automatic correct/incorrect determining unit 113, and an image printing unit 118 and a database creating unit 119 are connected to the image adding unit 116. A user interface including the operation panel of the color multifunctional machine 3 or the like may be used for the user interface 117, but the user interface 117 may also be configured by the display of the personal computer 5 or the like. In this embodiment, the constituent elements of the automatic grading apparatus 100 are described as such-and-such units, such as the identifying unit 111, but the such-and-such units are synonymous with such-and-such means. Also, correct answer information 121, point allocation information 122, problem position information 123, answer position information 124, and a handwriting font list 125 of a grader are stored in advance in the memory 120.

Image data of the answer sheet 8 inputted from the scanner 2 or 9 serving as image reading apparatus are inputted to the identifying unit 111. The identifying unit 111 is configured to identify correct/incorrect determination information from the image of the answer sheet 8 that has been read by the scanner 2 or 9 and in which is written correct/incorrect determination information where problems answered by text and figures have been determined to be correct or incorrect by a human hand.

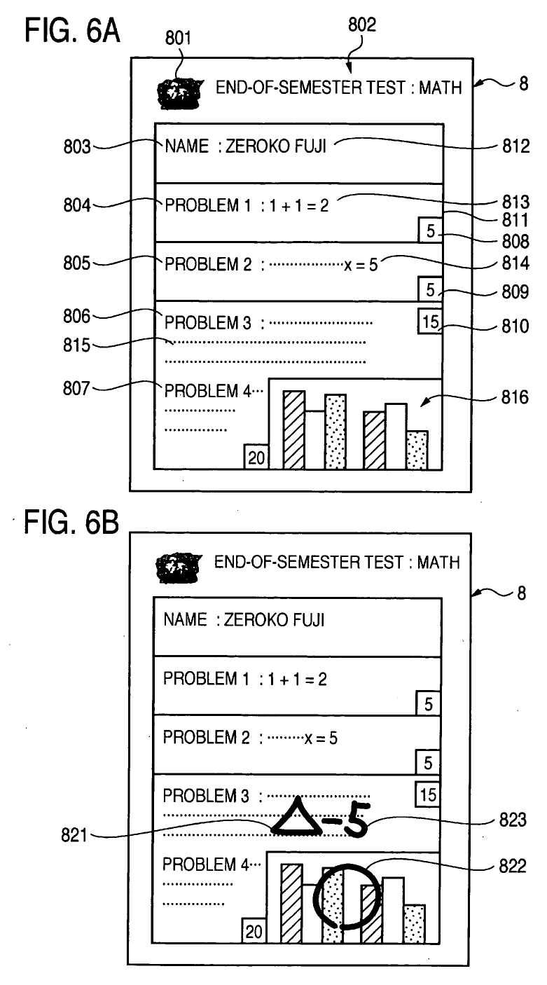

The answer sheets 8 read by the scanner 2 or 9 are not particularly limited. For example, as shown in FIG. 6A, the answer sheets 8 may be test papers used in schools, prep schools, or cram schools. However, the answer sheets 8 are not limited to these and may also be other types of answer sheets. As shown in FIG. 6A, a FIG. 801, such as a mark or illustration represents the company that created the answer sheet, a character image 802 represents the title of the answer sheet 8, such as “End-of-Semester Test” and the subject “Math.” Characters 803 of “Name” are written in a section where the test taker is to write his or her name. Sentences 804 to 807 includes characters representing problem numbers such as “Problem 1” and “Problem 2.” Numbers 808 to 810 represents the point allocations of the respective problems, and a linear frame image 811 represents a rectangular frame is printed in advance in the answer sheet 8. Also, the person taking the test writes a mark, a character, a sentence and so on in the answer sheet 8 with a black pencil or the like in handwriting, for example, a his or her name 812, a number 813 or numerical expression 814 as answers, or text 815 or a FIG. 816 as answers.

Also, FIG. 6B shows an example of the answer sheet which is marked by a teacher or the like. Correct/incorrect determination information including determination symbols 821 and 822, such as “◯,” “x,” and “Δ” serving as correct/incorrect determination results, and a subsidiary grade 823, such as “−5” serving as a determined to be correct or incorrect, are handwritten in the answer sheet 8 by the teacher with a red color pen, for example. The determination symbols are not limited as described above, they may include any kind of symbol, character, comment or the like.

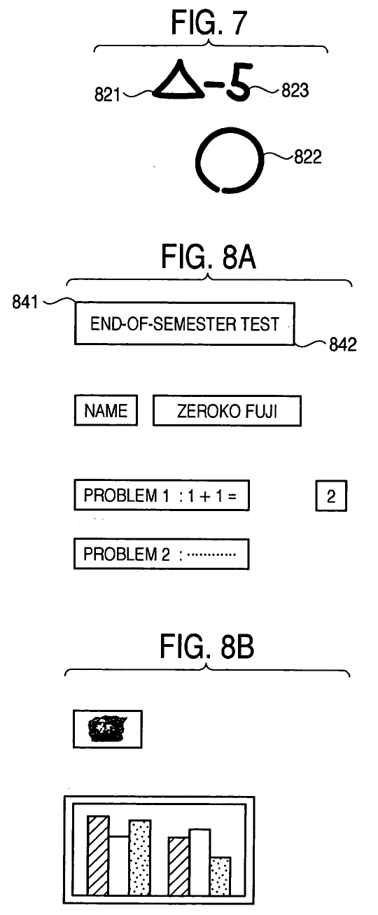

As shown in FIG. 7, after reading the answer sheet by the scanner 2 or 9, the identifying unit 111 identifies and discriminates the correct/incorrect determination information from the other information.

According to an aspect of the present information, the correct/incorrect determination information is identified based on the color of the image, for example, the correct/incorrect determination information includes the determination symbols 821 and 822, such as ◯, x, and Δ, which are written with the red pen whose color is different from the black of problem sentences and answers, and in this case the subsidiary grade 823, such as “−5” may also be written with red pen. Therefore, the correct/incorrect determination information is identified as shown in FIG. 7.

The identifying unit 111 is configured such that when the determination symbols 821 and 822 and the subsidiary grade 823 are written across some problems, the identifying unit 111 determines the correspondence between the problem and the determination symbols 821 and 822 and the subsidiary grade 823 based on whether the area positioned at any problem is large. It means that when it is difficult to decide which problem is related to the symbol, the related problem is determined as what has the large area most covered by the symbol. The identifying unit 111 is also configured such that when no determination symbols 821 and 822 are written, the identifying unit 111 issues a warning with the user interface 117. Moreover, when no correct/incorrect determination information is written, the identifying unit 111 adds a result of determining by the automatic correct/incorrect determining unit but does not send a signal to the score calculating unit 115. The identifying unit 111 is also configured to include a text/image separating function, a cutout function that cuts out an image in a rectangular shape, and a character recognition function such as OCR that automatically recognizes answers, problems, sentences and numbers.

The text/image separating function is a function that separates the inputted image data of the answer sheet 8 into text portions and image portions. This text/image separating function is configured by known text/image separating unit. Also, information of the text portions and the image portions separated by the text/image separating function is appropriately readably stored in the memory 120 separately for example.

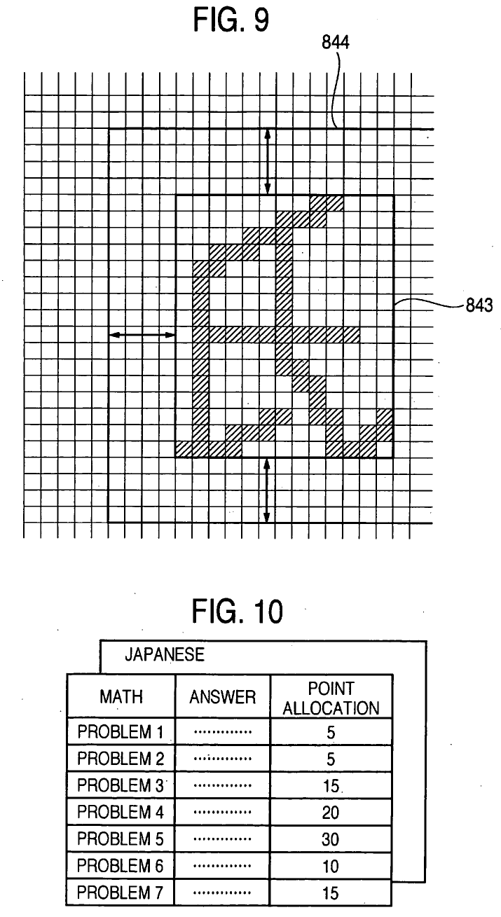

Also, the rectangle cutout function cuts out into at least one rectangular portion as shown in FIGS. 8A and 8B. The rectangle cutout function cuts out the rectangular portion form a automatic correct/incorrect determination portion and a non-automatic correct/incorrect determination portion of the answer sheet 8. Here, the automatic correct/incorrect determination portions shows portions of answers, for example, the 813 or 814 as shown in FIG. 6A, in which the answers can be automatically determined to be correct or incorrect. The non-automatic correct/incorrect determination portions shows portions of answers, for example, the 821 to 823 as shown in FIG. 6B. The answers written in the non-automatic correct/incorrect determination portions are not automatically determined to be correct or incorrect because the answer should be marked by considering depending on an occasion. As shown in FIGS. 8A and 8B, the rectangular portion is cut out by designating an upper left corner 841 and a lower right corner 842 with a touch panel or a mouse disposed in the user interface 117 of the color multifunctional machine 3. Also, as shown in FIG. 9, the rectangular portion may also be cut out by cutting a rectangular region 844 outside by a predetermined bit number from a rectangular portion 843. FIG. 9 shows an example that the rectangular portion 843 circumscribes an picture image and the rectangular region 844 is outside by a predetermined bit number from the 843. The rectangular cutout function may cut out plural characters or the like in the same rectangular region 844 if the interval between the adjacent characters is smaller than a predetermined bit number. An example of cutting out the rectangular portion is explained above but a portion of cutting out is not limited to the rectangular one.

In the OCR function, the image data cut out and separated as text portions by the text/image separating function as shown in FIG. 8A are character-recognized and converted to character information.

Moreover, the image extracting unit 112 extracts, on the basis of the results of identification by the identifying unit 111, the non-automatic correct/incorrect determination portions including the correct/incorrect determination information 821 to 823, and the automatic correct/incorrect determination portions 813 and 814 separately.

Additionally, the automatic correct/incorrect determining unit 113 determines whether the answer is correct or incorrect, which the answer is in the automatic correct/incorrect determination portions. The 113 determines it by comparing the answer with the correct answer information 121 stored in the memory 120 and/or the correct answer information calculated by the answer calculating unit 114. The answer is the converted character information. As shown in FIG. 6A, when the answer can be automatically calculated as in the numerical expression “1+1=,” the 113 determines whether the answer is correct or incorrect by comparing the answer with the correct answer information calculated by the answer calculating unit 114.

However, the automatic correct/incorrect determining unit 113 is not limited to this and may also be configured to conduct the correct/incorrect determination by storing the correct answers of the automatic correct/incorrect determination portions of the answer sheet 8 in advance in the memory 120 as shown in FIG. 10 and reading the correct answer information stored in the correct answer information 121 of the memory 120.

Also, the score calculating unit 115 calculates the score with respect to each problem in the answer sheet on the basis of the non-automatic correct/incorrect determination portions extracted by the image extracting unit 112 and the determination result of the automatic correct/incorrect determining unit 113. For example, as shown in FIGS. 6A and 6B, if the answer to “Problem 1” is correct, then a score of 5 points is calculated, and if the answer to “Problem 2” is incorrect, then a score of 0 points is calculated. Also, if the answer to “Problem 3” is partially correct (represented by “Δ”) and a subsidiary grade of “−5” is given, then a score of 10 points (=15−5) is calculated.

Moreover, on the basis of the scores calculated by the score calculating unit 115, the image adding unit 116 adds image data such as the scores and/or image data such as correct/incorrect determination marks such as “◯” and “x” to the answer of the automatic correct/incorrect determination portions 813 and 814 of the answer sheet 8. The image data for adding to the answer sheet 8 may be numbers representing scores stored in advance in the memory 120 and handwriting fonts in the handwriting font list 125 of the correct/incorrect determination marks such as “◯” and “x”, for example. The handwriting fonts in the list may be categorized by a person.

Also, the image adding unit 116 is configured to automatically write the correct answers to wrong answers in the answer sheet 8 and configured such that the function of automatically writing the correct answers can be selected by an instruction from the user interface 117.

The image forming unit A of the color multifunctional machine 3 is used as the image printing unit 118. In the image printing unit 118, the answer sheets 8 that are to be graded are set in the paper supply trays 41 to 44 or a manual-feed tray unillustrated, and the number of points graded and the automatically graded results such as ◯ and x are printed on the answer sheet 8, as shown in FIG. 11. At this time, the number of points graded and the automatically graded results such as ◯ and x printed on the answer sheet 8 are automatically reduced/enlarged in accordance with the answer position information.

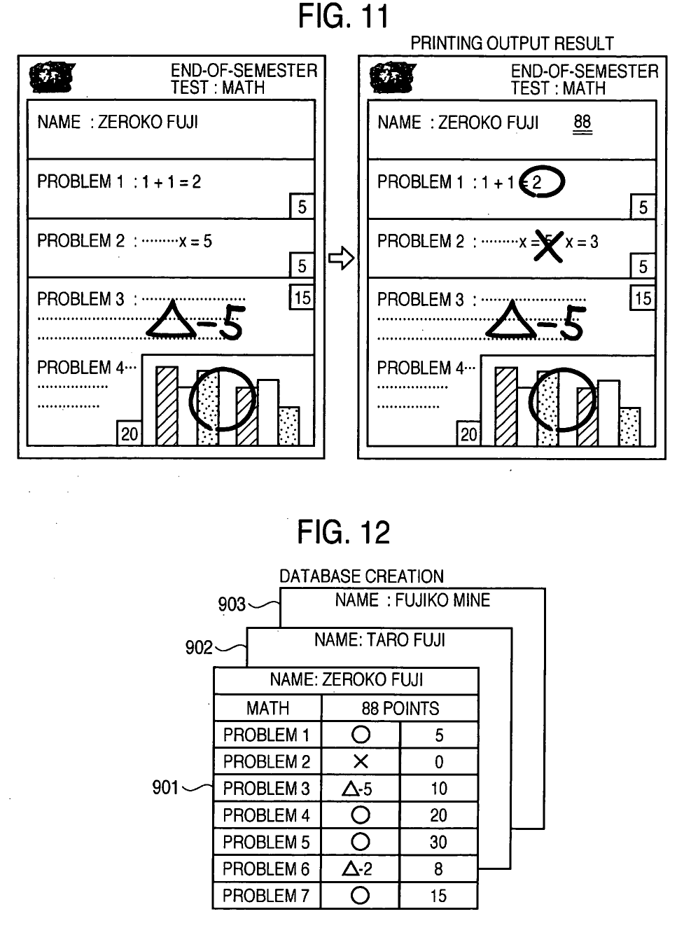

The image information added by the image adding unit 116 is sent to the database creating unit 119, where the results such as the number of points graded are generated as databases 901 to 903 including charts, such as Excel charts, as shown in FIG. 12.

In the above configuration, in the automatic grading apparatus according to this embodiment, dedicated hardware such as a dedicated pad and pen is not required, the configuration is simple, and realization is possible at a low cost, as follows. Moreover, it becomes possible to automatically grade answers by subsidiarily reading human grading results even if the problems are problems answered by text and figures.

That is, in the image processing system 1 to which the automatic grading apparatus 100 according to an aspect of the present invention is applied, as shown in FIG. 2, an image of the answer sheet 8 is read by the scanner 2 or the scanner 9 serving as image reading apparatus, and the image data of the answer sheet 8 read by the scanner 2 or 9, are inputted to the color multifunctional machine 3 serving as an image output apparatus disposed with the automatic grading apparatus 100 as shown in FIG. 1.

As shown in FIG. 6B, before the answer sheet 8 such as a test paper is read by the scanner 2 or 9, whether or not the problems answered by the text 815 and the FIG. 816 are correct or incorrect is subsidiarily determined in advance by the human hand of a grader such as a teacher. Correct/incorrect determination information including the determination symbols 821 and 822, such as ◯, x, and Δ serving as the correct/incorrect determination results, and the subsidiary grade 823, such as “−5” serving as the result determined to be correct or incorrect, are handwritten in the answer sheet 8 with a red color pen, for example.

As shown in FIG. 1, the image data of the answer sheet 8 read by the scanner 2 or 9 serving as image reading apparatus are inputted to the automatic grading apparatus 100, and the non-automatic correct/incorrect determination portions including the correct/incorrect determination information 821 to 823 of the inputted image data are identified by the identifying unit 111. The correct/incorrect determination information 821 to 823 identified by the identifying unit 111 is extracted by the image extracting unit 112 and separated into automatic correct/incorrect determination portions including characters and numerical values such as “2” and “x=5.”

The correct/incorrect determination information 821 to 823 that is the non-automatic correct/incorrect determination portions extracted by the image extracting unit 112 is sent to the score calculating unit 115, and the score is calculated on the basis of the correct/incorrect determination information 821 to 823 by the score calculating unit 115. Also, the automatic correct/incorrect determination portions extracted by the image extracting unit 112 are sent to the automatic correct/incorrect determining unit 113, their correctness/incorrectness is automatically determined by the automatic correct/incorrect determining unit 113, and the correct/incorrect determination results are sent to the score calculating unit 115.

Also, in a case where none of the correct/incorrect determination information 821 to 823 is extracted or in a case where the number of correct/incorrect determination information is less than a predetermined number when the non-automatic correct/incorrect determination portions are to be extracted by the image extracting unit 112, a warning is issued by displaying a warning message of “no correct/incorrect determination information has been written with respect to the problems answered by text and figures” on the user interface 117 via the automatic correct/incorrect determining unit 113.

Next, the information of the grading result such as ◯×Δ and the like with respect to the automatic correct/incorrect determination portions and the scores obtained by the score calculating unit 115 are sent to the image adding unit 116, where images of the correct/incorrect determination marks such as ◯×Δ and the scores are added on the basis of the image data of the answer sheet 8. As shown in FIG. 1, position information for adding images of the correct/incorrect determination marks such as ◯×Δ and the scores are determined on the basis of the problem position information 123 and the answer position information 124 in the memory 120 and the position information of the images 813 and 814 of the read answers.

At this time, the sizes of the images of the scores and the correct/incorrect determination marks such as ◯×Δ are configured such that the preregistered font information is reduced/enlarged to match the sizes of the answers and score sections and added.

Also, in the image adding unit 116, when correct/incorrect determination information is not written with respect to problems answered by text and figures, the determination results by the automatic correct/incorrect determining unit 113 are added, but automatic grading is not conducted.

Moreover, the image adding unit 116 is configured such that whether or not an image of a correct answer is to be added with respect to an incorrect problem can be selected by an instruction of the user interface 117. When an image of the correct answer is to be added with respect to an incorrect problem, an image of the correct answer, such as “x=3,” is added with respect to the incorrect problem, as shown in FIG. 11.

In this manner, in this embodiment, dedicated hardware such as a dedicated pad and pen is not required, the configuration is simple, and realization is possible at a low cost. Moreover, it becomes possible to automatically grade answers by subsidiarily reading human grading results even if the problems are problems answered by text or figures.

Also, in the above-described embodiment, it also becomes possible to create databases of the grading results as needed, as shown in FIG. 12.

As described above, an embodiment of the invention is outlined below.

The present invention provides an automatic grading apparatus that can be realized with a configuration that is simple, inexpensive, and does not require dedicated hardware such as a dedicated pad and pen, and which can automatically grade examination papers by subsidiarily reading human grading results even in the case of problems to be answered by text and figures.

According to an aspect of the present invention, an automatic grading apparatus that automatically grades by reading an image of an answer sheet including problems answered by text and figures, includes an identifying unit that identifies correct/incorrect determination information from an image of an answer sheet that has been read by an image reading apparatus and in which is written correct/incorrect determination information where problems answered by text and figures have been determined in advance to be correct or incorrect by a human hand; and a score calculating unit that calculates a score from preregistered point allocation information on the basis of the correct/incorrect determination information identified by the identifying unit.

According to an aspect of the present invention, an automatic grading apparatus that automatically grades by reading an image of an answer sheet including problems answered by text and figures, includes an identifying unit that identifies correct/incorrect determination information from an image of an answer sheet that has been read by an image reading apparatus and in which is written correct/incorrect determination information where problems answered by text and figures have been determined in advance to be correct or incorrect by a human hand; and a score calculating unit that calculates a score from preregistered point allocation information on the basis of the correct/incorrect determination information identified by the identifying unit.

According to another aspect of the invention, the automatic grading apparatus may further include a discriminating unit which, when the correct/incorrect determination information has been written in the state that it protrudes from a predetermined frame, discriminates which problem the correct/incorrect determination information corresponds to on the basis of the area ratio of the correct/incorrect determination information written inside the predetermined frame.

According to another aspect of the invention, in the automatic grading apparatus, automatically gradable answers in the image of the answer sheet may be recognized by a recognizing unit that automatically recognizes automatically gradable answers in the answer sheet, and the automatic grading apparatus may further include an automatic correct/incorrect determining unit that automatically determines whether the automatically gradable answers are correct or incorrect.

According to another aspect of the invention, the automatic grading apparatus may further include an image adding unit that automatically adds, to the answer sheet, an image of the score calculated by the score calculating unit.

According to another aspect of the invention, the automatic grading apparatus may further include a database creating unit that creates a database on the basis of the score calculated by the score calculating unit.

According to another aspect of the invention, the automatic grading apparatus may further include a warning unit that issues a warning when no correct/incorrect determination information has been written with respect to the problems answered by text and figures.

According to another aspect of the invention, in the automatic grading apparatus, when no correct/incorrect determination information has been written with respect to the problems answered by text and figures, the automatic grading apparatus may add the determination result resulting from the automatic correct/incorrect determining unit but does not conduct automatic grading.

According to another aspect of the invention, in the automatic grading apparatus, the image adding unit may be configured such that whether or not an image of a correct answer is to be added with respect to an incorrect problem.

According to another aspect of the invention, in the automatic grading apparatus, the image adding unit may use, as the image of the score to be automatically added to the answer sheet, at least preregistered handwriting font information of a grader.

According to another aspect of the invention, in the automatic grading apparatus, the image adding unit may reduce/enlarge the preregistered handwriting font information to match the sizes of answers and score columns.

According to an aspect of the present invention, an automatic grading apparatus can be provided which can be realized with a configuration that is simple, inexpensive, and does not require dedicated hardware such as a dedicated pad and pen, and which can automatically grade examination papers by subsidiarily reading human grading results even in the case of problems to be answered by text and figures.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims their equivalents.

The entire disclosure of Japanese Patent Application No. 2005-011542 filed on Jan. 19, 2005 including specification, claims, drawings and abstract is incorporated herein by reference in its entirety.

What is claimed is:

1. An automatic grading method comprising:
reading a document, the document having one or more answers;
identifying the answers from the document; and
calculating a score of the document based on a score of each answer.

2. The automatic grading method according to claim 1, wherein the document has an answer which has been marked by a human hand and the document has an answer which has not marked yet.

3. The automatic grading method according to claim 1, wherein the document has information that shows a score of each answer and the score of each answer is predetermined.

4. The automatic grading method according to claim 1, wherein information of the score is read from a database.

5. The automatic grading method according to claim 1, wherein a score of an answer which has been marked by a human hand is determined based on the handwriting marked information, and a score of an answer which has not marked yet is determined based on predetermined information.

6. An automatic grading apparatus comprising:
a reading unit that reads a document, the document having one or more answers;
a automatic grading unit that decides whether each answer is correct or incorrect, and automatically decides a score of the document based on a score of each answer;
a writing unit that writes the score on the document or information related to the decision whether each answer is correct or incorrect.

7. The automatic grading apparatus according to claim 6, wherein the score of each answer is determined from information of the document and the information is written in handwriting, and/or the score of each answer is determined from information and the information is printed in advance on the document or information and the information is predetermined in a database.

8. An automatic grading apparatus that automatically grades by reading an image of an answer sheet including problems answered by text and figures, the automatic grading apparatus comprising:
an identifying unit that identifies correct/incorrect determination information from an image of an answer sheet that has been read by an image reading apparatus and in which is written correct/incorrect determination information where problems answered by text and figures have been determined in advance to be correct or incorrect by a human hand; and
a score calculating unit that calculates a score from preregistered point allocation information on the basis of the correct/incorrect determination information identified by the identifying unit.

9. The automatic grading apparatus of claim 8, further comprising:
a discriminating unit which, when the correct/incorrect determination information has been written in the state that it protrudes from a predetermined frame, discriminates which problem the correct/incorrect determination information corresponds to on the basis of the area ratio of the correct/incorrect determination information written inside the predetermined frame.

10. The automatic grading apparatus of claim 8, wherein automatically gradable answers in the image of the answer sheet are recognized by a recognizing unit that automatically recognizes automatically gradable answers in the answer sheet, and the automatic grading apparatus further comprises an automatic correct/incorrect determining unit that automatically determines whether the automatically gradable answers are correct or incorrect.

11. The automatic grading apparatus of claim 8, further comprising:
an image adding unit that automatically adds, to the answer sheet, an image of the score calculated by the score calculating unit.

12. The automatic grading apparatus of claim 8, further comprising:
a database creating unit that creates a database on the basis of the score calculated by the score calculating unit.

13. The automatic grading apparatus of claim 9, further comprising:
a warning unit that issues a warning when no correct/incorrect determination information has been written with respect to the problems answered by text and figures.

14. The automatic grading apparatus of claim 10, wherein when no correct/incorrect determination information has been written with respect to the problems answered by text and figures, the automatic grading apparatus adds the determination result resulting from the automatic correct/incorrect determining unit but does not conduct automatic grading.

15. The automatic grading apparatus of claim 11, wherein the image adding unit is configured to allow to select whether or not an image of a correct answer is to be added with respect to an incorrect problem.

16. The automatic grading apparatus of claim 11, wherein the image adding unit uses, as the image of the score to be automatically added to the answer sheet, at least preregistered handwriting font information of a grader.

17. The automatic grading apparatus of claim 11, wherein the image adding unit reduces/enlarges the preregistered handwriting font information to match the sizes of answers and score columns.

18. A storage medium readable by a computer, the storage medium storing a program of instructions executable by the computer to perform a function for grading a document, the function comprising:
reading a document, the document having one or more answers;
deciding whether each answer is correct or incorrect;
deciding a score of the document based on a score of each answer automatically;
writing the score on the document or information related to the decision whether each answer is correct or incorrect.
